(19) United States
(12) Patent Application Publication
(10) Pub. No.: US 2014/0245375 A1
(43) Pub. Date: Aug. 28, 2014

(54) DOCUMENT AUTHORITY MANAGEMENT SYSTEM, TERMINAL DEVICE, DOCUMENT AUTHORITY MANAGEMENT METHOD, AND COMPUTER-READABLE RECORDING MEDIUM

(71) Applicant: NEC Corporation, Tokyo (JP)

(72) Inventor: SANEYUKI ISHII, Tokyo (JP)

(73) Assignee: NEC Corporation, Tokyo (JP)

(21) Appl. No.: 14/177,794

(22) Filed: Feb. 11, 2014

(30) Foreign Application Priority Data
Feb. 28, 2013 (JP) 2013-038669

(51) Int. Cl. H04L 29/06

(52) U.S. Cl. CPC H04L 63/08
USPC 726/1

(57) ABSTRACT

A document authority management system 100 includes a management server 30 that issues path information for document usage based on rights policies, a terminal device 10 that performs document protection based on rights policies and requests the management server 30 to issue path information when document usage is sought, and a communication terminal 50 configured to communicate wirelessly with the management server. The terminal device 10, upon document usage being sought in an offline state, creates authentication-use information for requesting issuance of path information, in a form supported by the communication terminal 50. The communication terminal 50 receives the authentication-use information, transmits the received authentication-use information to the management server 30, and, upon path information being transmitted thereto, changes the path information into a form supported by the terminal device 10.

### CROSS-REFERENCE TO RELATED APPLICATION

This application is based upon and claims the benefit of priority from Japanese patent application No. 2013-38669, filed on Feb. 28, 2013, the disclosure of which is incorporated herein in its entirety by reference.

### BACKGROUND OF THE INVENTION

1. Field of the Invention

The present invention relates to a document authority management system, a terminal device and a document authority management method for managing the user authority of documents to be protected, and a computer-readable recording medium storing a program for realizing the system, device and method.

2. Background Art

Following an escalation in the damage caused by the leakage of information in recent years, Information Rights Management (IRM) has been garnering attention as technology for protecting documents containing confidential information. IRM technology is characterized not only by simply encrypting documents but also by assigning users with authority (hereinafter, “rights policy information”) relating to operations performed on documents, such as viewing, printing and copying (e.g., see JP 2009-199390A).

When a user wants to use a document (hereinafter, “protected document”) that has been assigned rights policy information and encrypted using IRM technology, the user needs to access a management server that manages the rights policy information via a network and be authenticated. When authentication is confirmed, the user acquires the rights policy information permitted to him or her from the management server, uses this information to decrypt the protected document, and is able to use the protected document to the extent of the assigned rights policy information. IRM technology thus allows leakage of information to be suppressed, since users are only able to use documents to the extent of the assigned rights policy information.

However, when IRM technology is used, there is a problem in that protected documents cannot be used in an offline environment, since users are not able to access the rights policy information management server. There are thus calls for a way of enabling protected documents to also be used in an offline environment.

For example, JP 2007-207171A discloses a system that acquires the rights policy information of a user as cache information in an online environment, and holds this information on a client terminal. The system disclosed in JP 2007-207171A enables users to access protected documents in an offline environment by using the cached information, conceivably resolving the abovementioned problem.

A method for creating self-decrypting protected documents is known (URL: http://www.dataclasys.com/dataclasys/offline/index.html (http://www.dataclasys.com/wp-content/themes/twentyten/data/dataclasys_pdf_{—}121025 01.pdf): DATA Clasys Distributed Online Options, 2010, NESCO, Co., Ltd). With this method, the rights policy information and the protected document are formed as a single document at the stage of creating the self-decrypting protected document, and a password is set for this document. In this case, users who know the password are able to use the document even in an offline environment. In contrast, users who do not know the password at the time of wanting to use a document cannot use the document even if he or she is logged into the client terminal, enabling leakage of information to be suppressed.

However, the system disclosed in JP 2007-207171A requires that the user first create a cache in an online environment. Also, there is a problem in that although it is possible for rights policy information to be changed in the management server after the cache has been created, the change cannot be reflected in the cache in this case, thus rendering the latest rights policy information inapplicable.

The system disclosed in JP 2007-207171A is configured such that authentication is performed online at the time of creating the cache, and is not required at the time of using a protected document. There is thus the problem of low security, given that protected documents can be accessed by any user logged into the client terminal.

With the method for creating self-decrypting protected documents disclosed on the above website, rights policy information is set at the time of creating a self-decrypting protected document. There is thus a problem in that rights policy information cannot be changed after being created, meaning that the latest rights policy information also cannot be applied with this method. Also, with this method, a password is set when creating a self-decrypting protected document, and cannot be changed subsequently, meaning that nothing can be done in the event of the password being leaked or misused.

### SUMMARY OF THE INVENTION

An exemplary object of the present invention is to resolve the above problems and provide a document authority management system, a terminal device, a document authority management method and a program that enable application of the latest rights policy information and prevention of the leakage of confidential information to be achieved in the use of protected documents in an offline environment.

In order to attain the above object, a document authority management system according to one aspect of the present invention includes:

a management server that manages a rights policy defining a user authority of a document to be protected, and issues path information for using the document based on the rights policy;

a terminal device that protects the document based on the rights policy received from the management server, and, when use of the document is sought, requests the management server to issue the path information for using the document; and

a communication terminal configured to communicate wirelessly with the management server,

the terminal device, upon use of the document being sought when the terminal device is in an offline state with the management server, creating authentication-use information for requesting issuance of the path information, in a form supported by the communication terminal, and

the communication terminal, in a case where the authentication-use information is received, transmitting the received authentication-use information to the management server, and, upon the management server confirming that the authentication-use information is valid and transmitting the path information, changing the path information transmitted thereto into a form supported by the terminal device.

In order to attain the above object, a terminal device according to another aspect of the present invention is a terminal device for receiving, from a management server managing a rights policy that sets a user authority of a document to be protected, the rights policy, and protecting the document based on the received rights policy, that includes:

a protected document control unit that, upon use of the document being sought when the terminal device is in an offline state with the management server, creates authentication-use information for requesting the management server to issue path information that is required in order to use the document, in a form supported by a communication terminal configured to communicate wirelessly with the management server,

the protected document control unit, in a case where the communication terminal receives the authentication-use information and transmits the received authentication-use information to the management server, and the management server confirms that the authentication-use information is valid and transmits the path information to the communication terminal, acquiring the path information from the communication terminal in a form supported by the terminal device.

In order to attain the above object, a document authority management method according to yet another aspect of the present invention is a document authority management method in which are used a management server that manages a rights policy defining a user authority of a document to be protected and issues path information for using the document based on the rights policy, a terminal device that protects the document based on the rights policy received from the management server and requests the management server to issue the path information for using the document when use of the document is sought, and a communication terminal configured to communicate wirelessly with the management server, that includes the steps of:

(a) the terminal device, upon use of the document being sought when the terminal device is in an offline state with the management server, creating authentication-use information for requesting issuance of the path information in a form supported by the communication terminal;

(b) the communication terminal, in a case where the authentication-use information is received, transmitting the received authentication-use information to the management server; and

(c) the communication terminal, upon the management server confirming that the authentication-use information is valid and transmitting the path information to the communication terminal, changing the path information transmitted thereto into a form supported by the terminal device.

In order to attain the above object, a computer-readable recording medium according to yet another aspect of the present invention is a computer-readable recording medium storing a program for a computer to receive, from a management server managing a rights policy that sets a user authority of a document to be protected, the rights policy, and to protect the document based on the received rights policy, the program including instructions for causing the computer to execute the steps of:

(a) upon use of the document being sought when the computer is in an offline state with the management server, creating authentication-use information for requesting issuance of the path information, in a form supported by a communication terminal configured to communicate wirelessly with the management server; and

(b) in a case where the communication terminal receives the authentication-use information and transmits the received authentication-use information to the management server, and the management server confirms that the authentication-use information is valid and transmits the path information to the communication terminal, acquiring the path information from the communication terminal in a form supported by the computer.

The present invention enables application of the latest rights policy information and prevention of the leakage of confidential information to be achieved in the use of protected documents in an offline environment.

### BRIEF DESCRIPTION OF THE DRAWINGS

FIG. 1 is a block diagram showing a schematic configuration of a document authority management system according to an embodiment of the present invention.

FIG. 2 is a block diagram showing a specific configuration of a protected document authority management system according to an embodiment of the present invention.

FIG. 3 shows an example of rights policy information that is used in an embodiment of the present invention.

FIG. 4 shows an example of a rights policy template that is used in an embodiment of the present invention.

FIG. 5 shows an example of user information that is used in an embodiment of the present invention.

FIG. 6 is a flowchart showing document protection processing that is performed by a terminal device according to an embodiment of the present invention.

FIG. 7 shows an example of the data configuration of a protected document according to an embodiment of the present invention.

FIG. 8 is a flowchart showing operations of a terminal device in an offline environment according to an embodiment of the present invention.

FIG. 9 is a flowchart showing operations of a communication terminal according to an embodiment of the present invention.

FIG. 10 is a flowchart showing operations of a management server according to an embodiment of the present invention.

FIG. 11 is a flowchart showing operations of a user management server according to an embodiment of the present invention.

FIG. 12 shows an example of authentication-use information generated by a terminal device in an embodiment of the present invention.

FIG. 13 shows an example of complete authentication information that is generated in an embodiment of the present invention.

FIG. 14 shows an example of path information that is generated in an embodiment of the present invention.

FIG. 15 is a block diagram showing an example of a computer that realizes a terminal device according to an embodiment of the present invention.

### EXEMPLARY EMBODIMENT

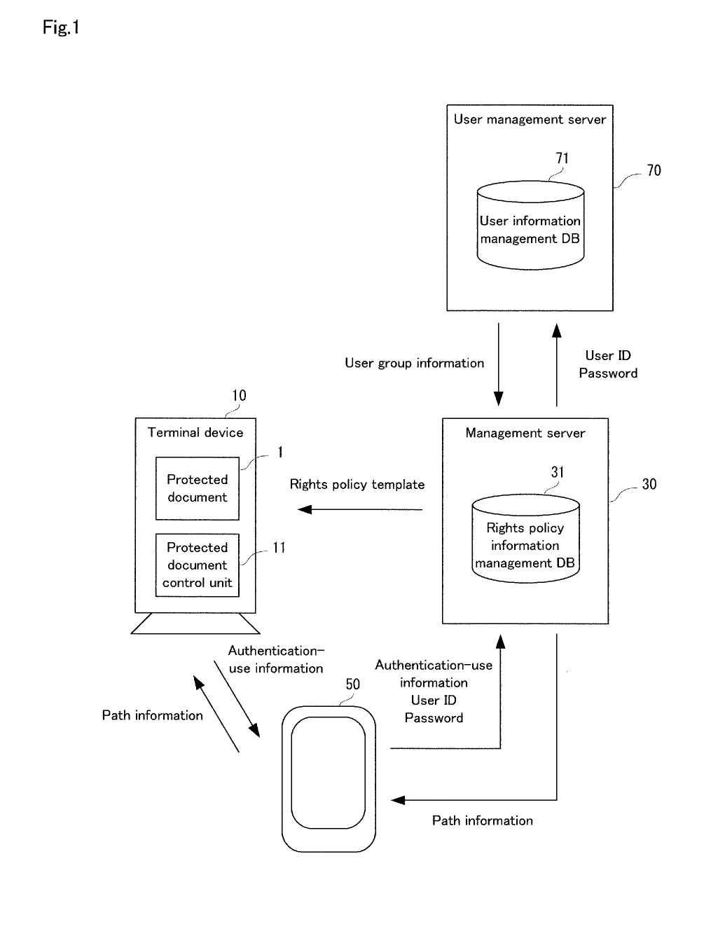

Hereinafter, a document authority management system, a terminal device, a document authority management method and a program according to an exemplary embodiment of the present invention will be described, with reference to FIGS. 1 to 15.

### System Configuration

Initially, the configuration of the document authority management system according to the exemplary embodiment of the present invention will be described using FIG. 1. FIG. 1 is a block diagram showing a schematic configuration of the document authority management system according to the present embodiment.

As shown in FIG. 1, a document authority management system 100 according to the present embodiment is a system for managing the user authority of documents that are to be protected, and is mainly provided with a terminal device 10 serving as a client terminal, a management server 30, and a communication terminal 50. Note that although only one terminal device 10 is illustrated in the example of FIG. 1, the number of terminal devices 10 is not particularly limited in the present embodiment.

Of these, the management server 30 manages rights policies defining the user authority of documents that are to be protected, and issues path information for using documents based on the rights policies. The communication terminal 50 is a terminal device capable of wireless communication with the management server, and is, for example, a mobile phone, a smart phone or a tablet terminal.

The terminal device 10 protects a document 1 based on the rights policy received from the management server 30. Furthermore, the terminal device 10, upon use of the document 1 being sought when the terminal device 10 is in an online state with the management server 30, sends authentication-use information to the management server 30 and requests issuance of path information for using the document 1. The management server 30 determines whether the authentication-use information transmitted thereto is valid, and, if valid, transmits path information to the terminal device 10.

Incidentally, the terminal device 10 is able to directly request the management server 30 to issue path information when in an online state with the management server 30, but is unable to directly request issuance of path information when in an offline state with the management server 30. Thus, the terminal device 10, upon use of a document (hereinafter, “protected document”) 1 that is protected being sought when in an offline state with the management server 30, creates authentication-use information for requesting issuance of path information, in a form supported by the communication terminal 50.

The communication terminal 50, in the case where authentication-use information is received, then transmits the received authentication-use information to the management server 30. Also, the communication terminal 50, upon the management server 30 confirming that the authentication-use information is valid and transmitting path information, changes the path information transmitted thereto into a form supported by the terminal device 10.

In this way, in the embodiment, issuance and transmission of path information required in use of the protected document 1 are performed via the communication terminal 50, when the terminal device 10 and the management server 30 are in an offline state. The present embodiment thus enables use of the protected document 1 in an offline environment. Also, because path information, rather than cached information, is issued by the management server 30 whenever there is a request, application of the latest rights policy information is possible, and, furthermore, prevention of the leakage of confidential information is also achieved.

As shown in FIG. 1, in the present embodiment, the document authority management system 100 is provided with a user management server 70 that manages user information. User information is used when authentication processing is performed in the management server 30, as will be discussed later. Also, user information is information specifying, for each user, a username, an ID, a password, a group name of an affiliated group to which the user belongs, and the like.

The terminal device 10 is provided with a protected document control unit 11 in order to realize the abovementioned functions. The protected document control unit 11, first, executes protection of the protected document 1 that is to be protected, based on the rights policy. Also, the protected document control unit 11, upon use of the protected document 1 being sought when the terminal device 10 is in an online state with the management server 30, requests the management server 30 to issue path information for using the protected document 1.

Furthermore, the protected document control unit 11, upon use of the protected document 1 being sought when the terminal device 10 is in an offline state with the management server 30, creates authentication-use information for requesting issuance of path information, in a form supported by the communication terminal 50.

Then, the protected document control unit 11, in the case where authentication-use information has been received by the communication terminal 50 and transmitted to the management server 30, and the management server 30 has confirmed that the authentication-use information is valid and transmitted path information to the communication terminal 50, acquires the path information from the communication terminal 50 in a form supported by the terminal device 10. Also, in the present embodiment, the protected document control unit 11 is constructed by a program installed in the terminal device 10.

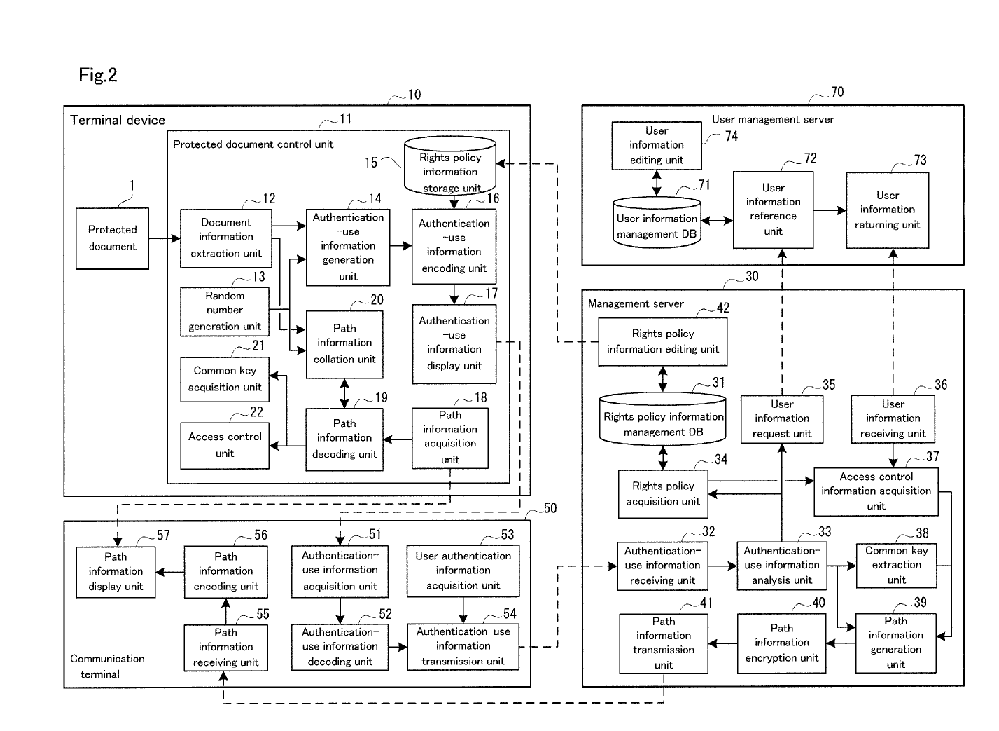

Next, the configuration of the protected document authority management system according to the present embodiment will be described more specifically using FIG. 2. FIG. 2 is a block diagram showing a specific configuration of the protected document authority management system according to the present embodiment.

### Terminal Device

As shown in FIG. 2, in the terminal device 10, the protected document control unit 11 is provided with a document information extraction unit 12, a random number generation unit 13, an authentication-use information generation unit 14, a rights policy information storage unit 15, an authentication-use information encoding unit 16, an authentication-use information display unit 17, a path information acquisition unit 18, a path information decoding unit 19, a path information collation unit 20, a common key acquisition unit 21, and an access control unit 22.

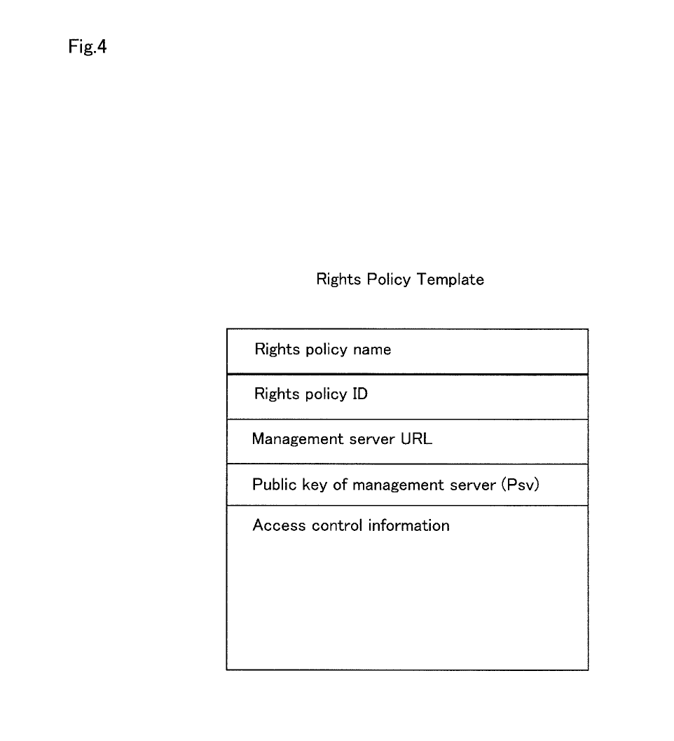

The document information extraction unit 12 extracts document information required in authentication from the protected document 1. The random number generation unit 13 generates a random number to be included in the authentication-use information. The authentication-use information generation unit 14 generates authentication-use information. Also, the rights policy information storage unit 15 stores a rights policy template (see FIG. 4 discussed below) acquired from the management server 30. The authentication-use information encoding unit 16 encodes the authentication-use information. The authentication-use information display unit 17 displays the encoded authentication-use information on a display screen (not shown in FIGS. 1 and 2) of the terminal device 10.

The path information acquisition unit 18 receives input of the path information by the user in an offline environment. The path information decoding unit 19, upon encoded path information being input, decodes the input path information. The path information collation unit 20 checks whether the random number that was included in the authentication-use information matches a random number acquired from the path information.

The common key acquisition unit 21 decrypts the protected document 1 using a common key acquired from the path information. The access control unit 22 controls use of the protected document 1 in accordance with rights policy information acquired from the path information.

### Communication Terminal

As shown in FIG. 2, the communication terminal 50 is provided with an authentication-use information acquisition unit 51, an authentication-use information decoding unit 52, a user authentication information acquisition unit 53, an authentication-use information transmission unit 54, a path information receiving unit 55, a path information encoding unit 56, and a path information display unit 57.

The authentication-use information acquisition unit 51 receives input of the authentication-use information displayed on the screen of the terminal device 10 in response to an operation by the user. The authentication-use information decoding unit 52, upon encoded authentication-use information being input, decodes the input authentication-use information. The user authentication information acquisition unit 53 acquires authentication information of the user. The authentication-use information transmission unit 54 transmits the decoded authentication-use information and the user authentication information of the user to the management server 30.

The path information receiving unit 55 receives path information sent back from the management server 30. The path information encoding unit 56 encodes the received path information. The path information display unit 57 displays the encoded path information on a display screen (not shown in FIGS. 1 and 2) of the communication terminal 50.

### Management Server

As shown in FIG. 2, the management server 30 is provided with a rights policy information management database 31, an authentication-use information receiving unit 32, an authentication-use information analysis unit 33, a rights policy acquisition unit 34, a user information request unit 35, and a user information receiving unit 36. The management server 30 is, in addition to the above, also provided with an access control information acquisition unit 37, a common key extraction unit 38, a path information generation unit 39, a path information encryption unit 40, a path information transmission unit 41, and a rights policy information editing unit 42.

The rights policy information management database 31 manages rights policy information discussed later. Also, “database” may be written as “DB” in the following description. The rights policy information editing unit 42 performs processing such as editing rights policy information managed by the rights policy information control DB 31 and creating new rights policy information.

The authentication-use information receiving unit 32 receives authentication-use information transmitted from the communication terminal 50. The authentication-use information analysis unit 33 analyzes the acquired authentication-use information, and distributes the analysis result to various units. The rights policy acquisition unit 34 uses a rights policy ID acquired from the authentication-use information to acquire the latest information on the corresponding rights policy from the rights policy information control DB 31.

The user information request unit 35, in order to acquire user information, transmits the user authentication information included in the authentication-use information received by the authentication-use information receiving unit 32 to the user management server 70. The user information receiving unit 36 receives the user information sent back from the user management server 70.

The access control information acquisition unit 37 specifies, from the received user information and the acquired rights policy information, access control information to be assigned to the user. The common key extraction unit 38 uses a document encryption key (server protection) acquired from the authentication-use information to acquire a common key used in encrypting the document, and converts the acquired common key to a document encryption key (client protection).

The path information generation unit 39 generates path information, using the random number and the document ID acquired from the authentication-use information, the access control information acquired by the access control information acquisition unit 37, and the document encryption key (client protection) acquired by the common key extraction unit 38. The path information encryption unit 40 encrypts the generated path information with a public key of the protected document control unit 11 in the terminal device 10. The path information transmission unit 41 transmits the encrypted path information to the communication terminal 50.

### User Management Server

As shown in FIG. 2, the user management server 70 is provided with a user information management DB 71, a user information reference unit 72, a user information returning unit 73, and a user information editing unit 74.

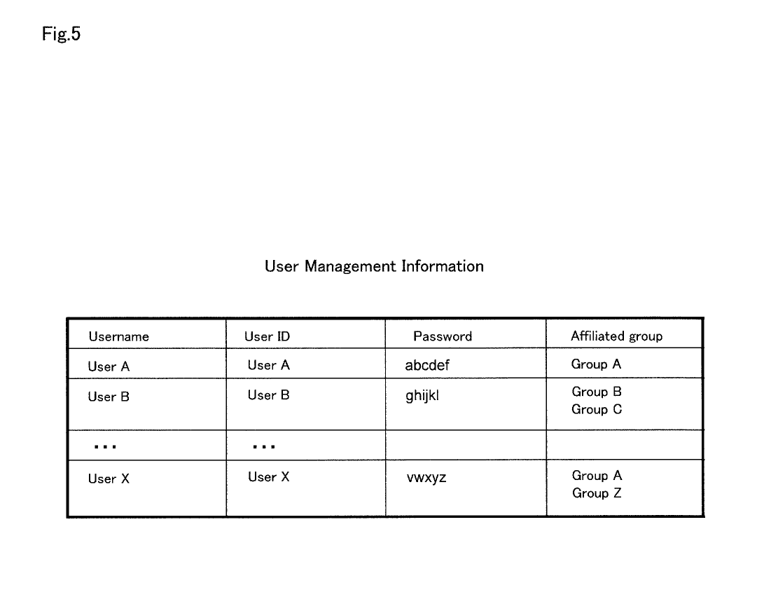

The user information management DB 71 stores and manages user information (see FIG. 5 discussed below). The user information reference unit 72 refers to the user authentication information transmitted from the management server 30 in the user information management DB 71, and confirms that the corresponding user exists. Then, in the case where the user exists, the user information reference unit 72 acquires user information about that user (username, ID, password, group name of affiliated group, etc.) from the user information management DB 71.

The user information returning unit 73 sends back the user information acquired by the user information reference unit 72 to the management server 30 from which the request was received. The user information editing unit 74 performs processing such as editing user information managed by the user information management DB 71, adding new users, and setting new groups.

Note that, in the present embodiment, the terminal device 10 (protected document control unit 11) and the management server 30 respectively have a pair of a public key and a private key in order to encrypt the authentication-use information, path information and common key that are transmitted therebetween.

### Rights Policy Information

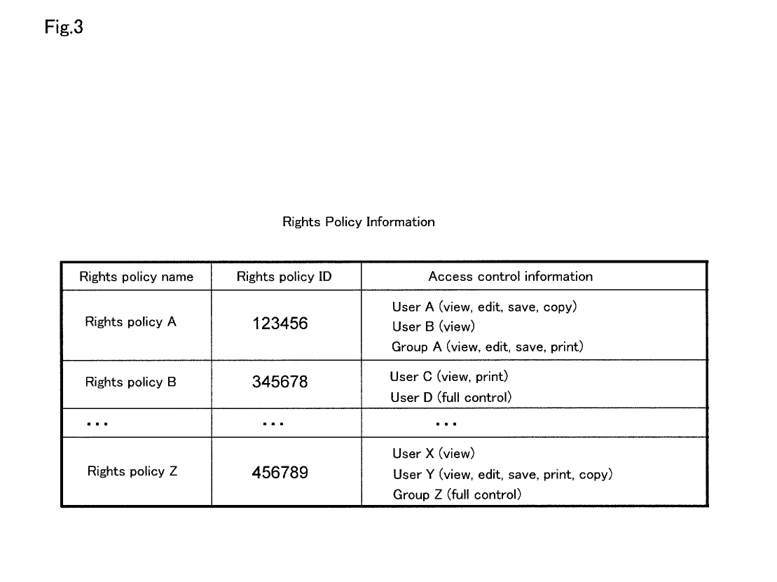

Next, rights policy information that is used in the present embodiment will be described using FIGS. 3 and 4. FIG. 3 shows an example of rights policy information that is used in the present embodiment. FIG. 4 shows an example of a rights policy template that is used in the present embodiment.

Rights policy information is, as described above, stored in the rights policy information control DB 31 of the management server 30. Also rights policy information is created by the rights policy information editing unit 42 as a result of an operation input by the administrator of the management server 30, and thereafter stored in the rights policy information control DB 31.

As shown in FIG. 3, rights policy information is constituted by one or more right policies. Each rights policy is assigned a unique rights policy ID. Also, the details of operations permitted to each user or each group, such as full control, viewing, editing, saving, printing and copying, for example, are registered in each rights policy.

Rights policy information is converted into the rights policy template shown in FIG. 4 at the time of distribution to the terminal devices 10, and is thereafter distributed to the protected document control unit 11 of each terminal device 10. The rights policy template distributed to the terminal devices 10 is then stored in the rights policy information storage unit 15 in the protected document control unit 11, and managed there.

As shown in FIG. 4, the rights policy template is created by assigning the management server URL and the public key (Psv) of the management server to the rights policies managed in the rights policy information control DB 31. Note that the management server URL is the URL that is accessed when authentication is performed with the management server 30.

### User Information

Next, user information that is used in the present embodiment will be described using FIG. 5. FIG. 5 shows an example of user information that is used in the present embodiment.

User information is, as described above, stored in the user information management DB 71 of the user management server 70. Also, user information is created by the user information editing unit 74 as a result of an operation input by the administrator of the user management server 70, and thereafter stored in the user information management DB 71. As shown in FIG. 5, user information is constituted, for each user, by a username, a user ID, a password, a group name of an affiliated group, and the like.

### System Operations

Next, operations of the protected document authority management system 100 according to the present embodiment will be described using the drawing. In the following description, FIGS. 1 to 5 will be referred to as appropriate. Also, in Embodiment 1, the protected document authority management method is implemented by operating the protected document authority management system 100. Therefore, description of a protected document authority management method in the present embodiment is replaced with the following description of the operations of the protected document authority management system 100.

In the present embodiment, as prior preparation, the rights policy information shown in FIG. 3 is created in the management server 30, and the required rights policy is distributed to each terminal device 10. Also, user information is created in the user management server 70.

### Document Protection Processing

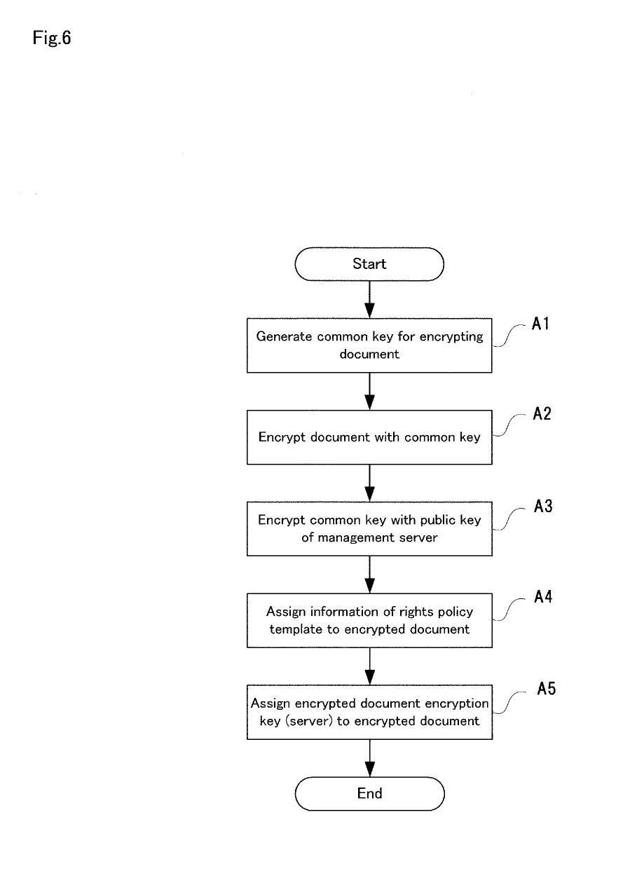

First, processing in the terminal device 10 when protecting a document using a rights policy template (see FIG. 4) will be described using FIG. 6. The protection of a document using a rights policy template involves encrypting the document using the information of the rights policy template stored in the rights policy information storage unit 15 of the terminal device 10, in a state where access control information has been assigned to the document.

FIG. 6 is a flowchart showing document protection processing that is performed by the terminal device according to the present embodiment. As shown in FIG. 6, first, the protected document control unit 11 generates a common key (K) (step A1), and encrypts the document using the common key (K) (step A2).

Next, the protected document control unit 11 acquires the public key information (Psv) of the management server 30 from the rights policy template stored in the rights policy information storage unit 15, and encrypts (Psv[K]) the common key (K) using public key information (Psv) (step A3).

Next, the protected document control unit 11 assigns the information of the rights policy template (rights policy ID, management server URL) to the document encrypted at step A2 (step A4). Furthermore, the protected document control unit 11 assigns the encrypted common key (Psv[K]) to the encrypted document to which the information was assigned at step A4 (step A5). Note that the encrypted common key is referred to as a “document encryption key”.

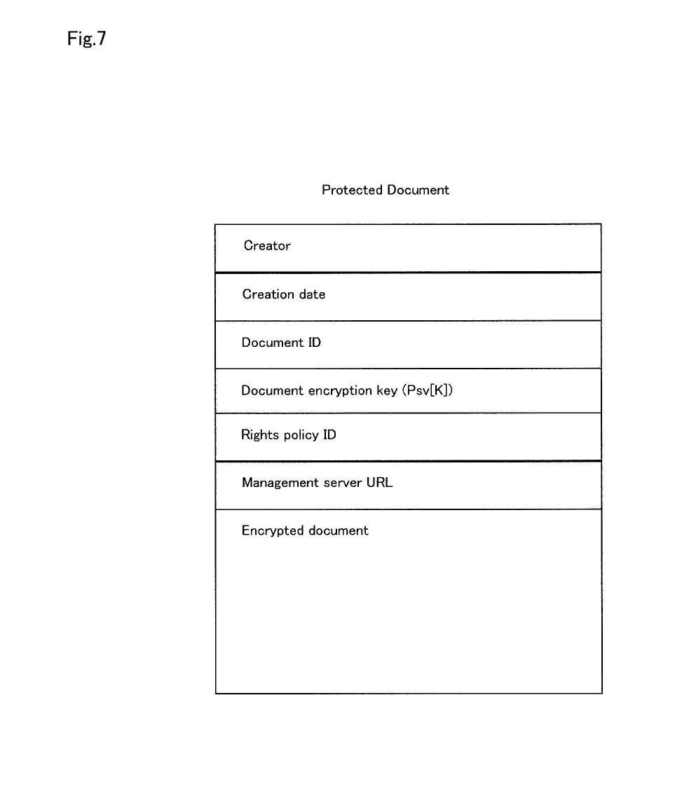

As a result, the protected document shown in FIG. 7 is generated. FIG. 7 shows an example of a data configuration of a protected document according to the present embodiment. As shown in FIG. 7, a creator, a creation date and a unique document ID are also assigned to the protected document (encrypted document), in addition to the rights policy ID, the management server URL, and the encrypted common key (Psv[K]).

### Operations of Terminal Device in an Offline Environment

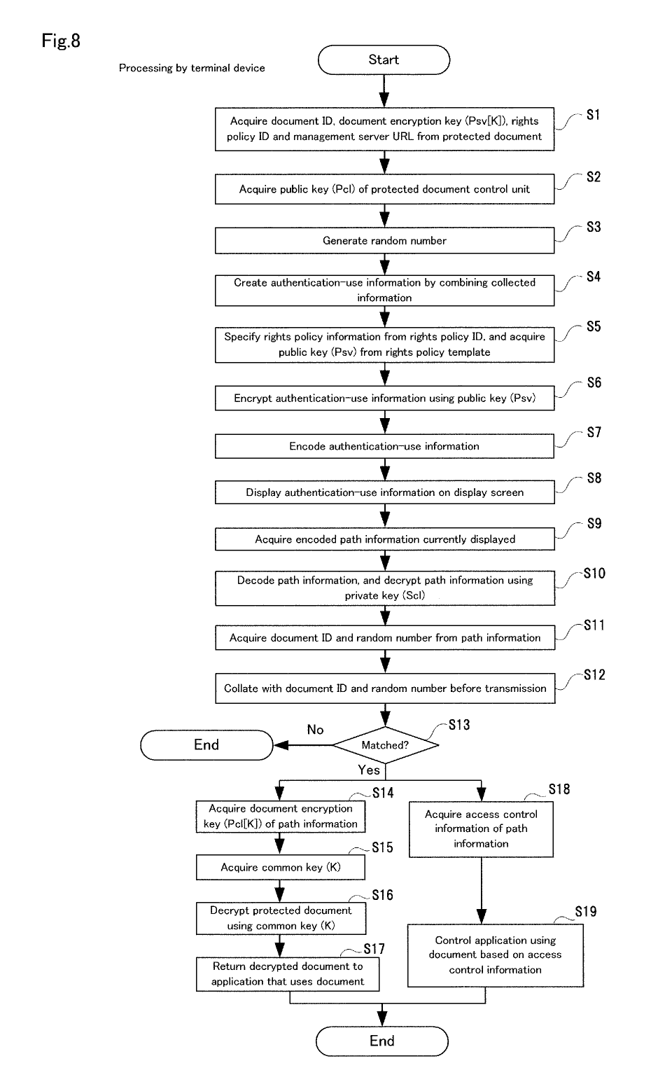

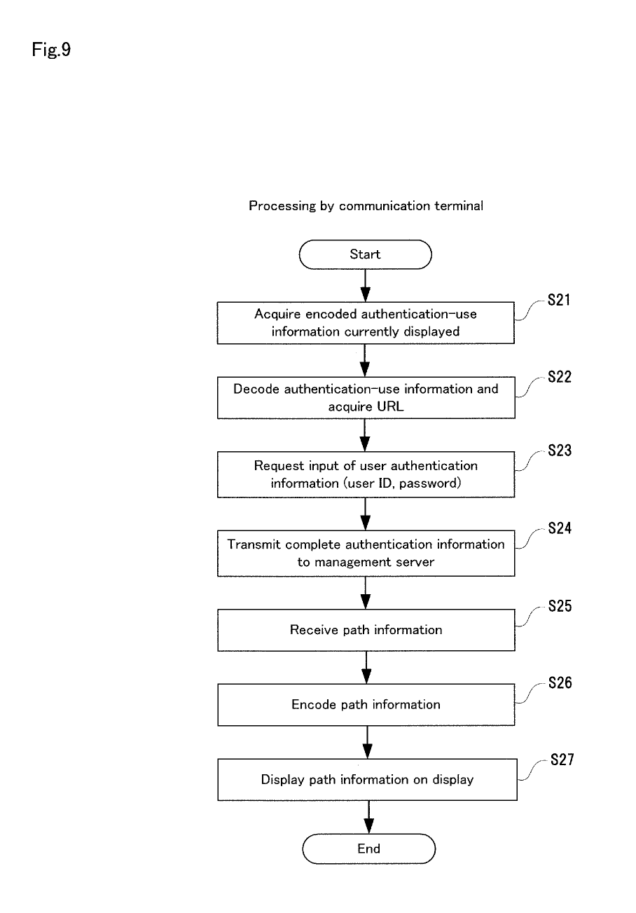

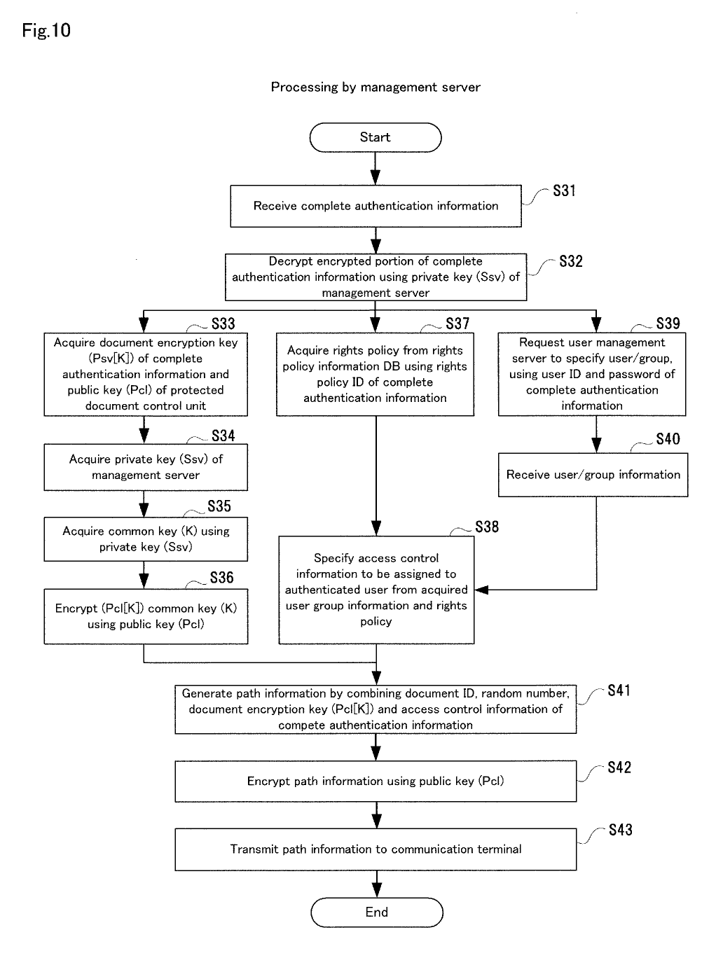

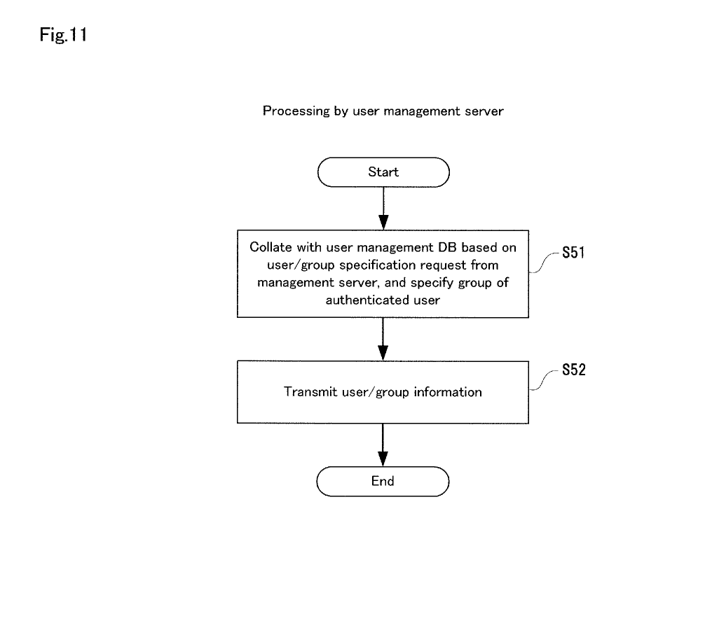

Next, the operations of the system in the case of using a protected document on the terminal device 10 in an offline environment will be described using FIGS. 8 to 11. FIG. 8 is a flowchart showing operations of the terminal device in an offline environment according to the present embodiment. FIG. 9 is a flowchart showing operations of the communication terminal according to the present embodiment. FIG. 10 is a flowchart showing operations of the management server according to the present embodiment. FIG. 11 is a flowchart showing operations of the user management server according to the present embodiment.

### Operations by Terminal Device

First, when a user tries to use a protected document on the terminal device 10 in the case where the terminal device 10 is in offline environment, the protected document control unit 11 intervenes and the following processing is performed. As shown in FIG. 8, the document information extraction unit 12 acquires a document ID, a document encryption key (Psv[K]), a rights policy ID, and a rights policy management server URL from the protected document 1 (step S1). The document information extraction unit 12 passes the acquired information to the authentication-use information generation unit 14, and also passes the document ID to the path information collation unit 20.

Next, the document information extraction unit 12 acquires the public key (Pcl) of the protected document control unit 11, and also passes the acquired public key to the authentication-use information generation unit 14 (step S2).

After step S2 or in parallel with steps S1 and S2, the random number generation unit 13 generated a random number, and passes the generated random number to the authentication-use information generation unit 14 and the path information collation unit 20 (step S3).

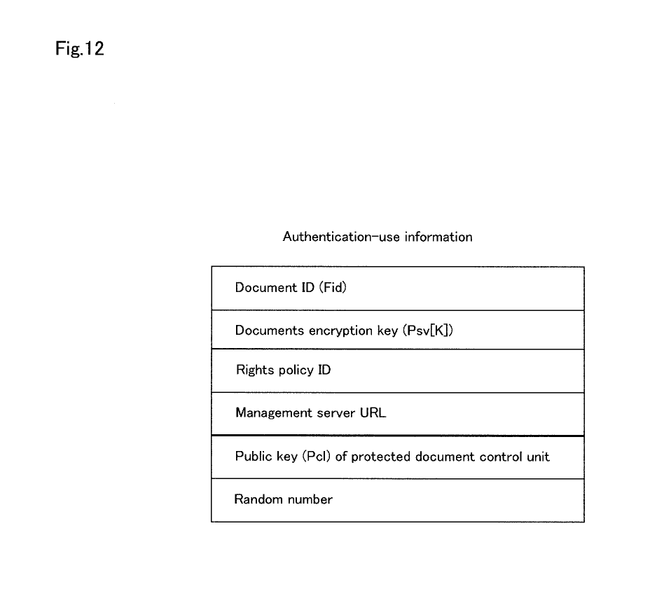

Next, the authentication-use information generation unit 14 combines the random number received from the random number generation unit 13 with the document ID, document encryption key (Psv[K]), rights policy ID, management server URL, and the public key (Pcl) of the protected document control unit 11 received from the document information extraction unit 12 (step S4). The authentication-use information shown in FIG. 12 is thereby generated. The authentication-use information generation unit 14 passes the generated authentication-use information to the authentication-use information encoding unit 16. FIG. 12 shows an example of authentication-use information that is generated by the terminal device according to the present embodiment.

Next, the authentication-use information encoding unit 16 specifies a rights policy template having the same ID as the rights policy ID of the authentication-use information, from among the rights policy templates stored in the rights policy information storage unit 15. The authentication-use information encoding unit 16 then acquires the public key (Psv) (see FIG. 4) of the management server 30 that is included in the specified rights policy template (step S5).

Next, the authentication-use information encoding unit 16 uses the public key (Psv) to encrypt portions of the authentication-use information other than the management server URL (step S6). The authentication-use information encoding unit 16 then encodes all of the authentication-use information with a method capable of displaying the encrypted authentication-use information on a screen, such as QR Code (registered trademark) or BASE64 (step S7). Also, the authentication-use information encoding unit 16 passes the encoded authentication-use information to the authentication-use information display unit 17.

Next, the authentication-use information display unit 17 displays the authentication-use information encoded by the authentication-use information encoding unit 16 on the display screen of the terminal device 10 (step S8). The encoded authentication information is thereby conveyed to the user.

### Operations by Communication Terminal

Next, when step S8 has been executed, the authentication-use information acquisition unit 51 of the communication terminal 50, as shown in FIG. 9, acquires the code of the authentication-use information currently displayed on the screen of the terminal device 10, in accordance with operation of the communication terminal 50 by the user (step S21).

Specifically, for example, the communication terminal 50 may be provided with a digital camera, and the authentication-use information may converted to a two-dimensional code, such as QR Code (registered trademark), in step S7, and the two-dimensional code may be displayed on the screen of the terminal device 10 in step S8. In this case, the authentication-use information acquisition unit 51 is able to acquire the code of the authentication-use information by analyzing an image of the code captured by the user with the digital camera of the communication terminal 50.

As another example, the authentication-use information may be encoded using BASE64 in step S7 and a character string or the like may be displayed in step S8. In this case, the authentication-use information acquisition unit 51 is able to acquire the code of the authentication-use information after an input operation by the user.

Next, the authentication-use information decoding unit 52 decodes the encoded authentication-use information acquired at step S21, and passes the decoded authentication-use information to the authentication-use information transmission unit 54 (step S22).

Next, after execution of step S22 or in parallel with steps S21 and S22, the user authentication information acquisition unit 53 displays a message on the display screen and requests the user to input a user ID and a password (step S23). In this case, the user authentication information acquisition unit 53 passes the input user ID and password to the authentication-use information transmission unit 54 as user authentication information.

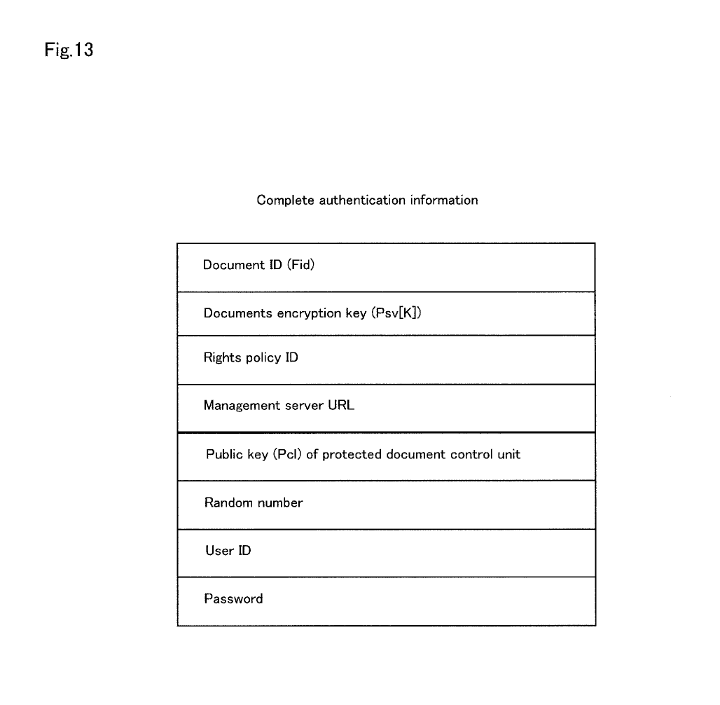

Next, the authentication-use information transmission unit 54 combines the authentication-use information received from the authentication-use information decoding unit 52 and the user authentication information (user ID, password) received from the user authentication information acquisition unit 53, and generates the complete authentication information shown in FIG. 13. FIG. 13 shows an example of complete authentication information generated in the present embodiment.

The authentication-use information transmission unit 54 then acquires the management server URL from the complete authentication information, and transmits the complete authentication information to the management server 30 (step S24). At this time, the authentication-use information transmission unit 54 is able to use existing technology such as SSL to encrypt the information to be transmitted, thereby further ensuring the security of the information to be transmitted.

### Operations by Management Server

Next, when step S24 has been executed, in the management server 30 the authentication-use information receiving unit 32, as shown in FIG. 10, receives the complete authentication information sent from the communication terminal 50, and passes the received information to the authentication-use information analysis unit 33 (step S31).

Next, the authentication-use information analysis unit 33 decrypts the portion of the complete authentication information encrypted with the public key (Psv) of the management server 30 (in the present embodiment, portion excluding the user ID, password and management server URL), using the private key (Ssv) of the management server 30 (step S32)

Next, the authentication-use information analysis unit 33 passes the document encryption key (Psv[K]) and the public key (Pcl) of the protected document control unit 11 in the decrypted complete authentication information to the common key extraction unit 38. Also, the authentication-use information analysis unit 33 passes the rights policy ID in the decrypted complete authentication information to the rights policy acquisition unit 34, and passes the user ID and the password to the user information request unit 35. The authentication-use information analysis unit 33 also passes the document ID and the random number to the path information generation unit 39.

After execution of step S32, the common key extraction unit 38 acquires the document encryption key (Psv[K]) and the public key (Pcl) of the protected document control unit 11 (step S33). Also, the common key extraction unit 38 acquires the private key (Ssv) of the management server 30 (step S34).

Next, the common key extraction unit 38 decrypts the document encryption key (Psv[K]) received from the authentication-use information analysis unit 33 using the private key (Ssv) of the management server 30, and acquires a common key (K) (step S35).

Next, the common key extraction unit 38 encrypts the common key (K) using the public key (Pcl) of the protected document control unit 11, and generates a document encryption key (Pcl[K]) (step S36). The common key extraction unit 38 then passes the document encryption key (Pcl[K]) and the public key (Pcl) of the protected document control unit 11 to the path information generation unit 39.

After execution of step S32, the rights policy acquisition unit 34 acquires, from the rights policy information control DB 31, a rights policy having the same ID as the rights policy ID received from the authentication-use information analysis unit 33, and passes the acquired rights policy to the access control information acquisition unit 37 (step S37).

After execution of step S32, the user information request unit 35 transmits the user ID and the password received from the authentication-use information analysis unit 33 to the user management server 70, in order to specify the user and the affiliated group (step S39).

### Operations by User Management Server

When step S39 has been executed, processing is performed in the user management server 70. As shown in FIG. 11, first, in the user management server 70, the user information reference unit 72 collates the user ID and the password transmitted from the management server 30 with the user information management DB 71. The user information reference unit 72 then confirms the existence of the corresponding user, and, if the user exists, extracts the affiliated group (step S51).

Next, the user information reference unit 72 passes the information specifying the extracted group and the corresponding user (hereinafter, “user group information”) to the user information returning unit 73. The user information returning unit 73 thereby transmits user group information to the management server 30 (step S52).

Taking FIG. 5 as an example, in the case where the user ID and the password are respectively “UserA” and “abcdef”, the user will be “user A” and the affiliated group will be “group A.” Therefore, group A is extracted at step S51, and group A and user A are transmitted to the management server 30 as user group information.

### Operations by Management Server

When step S52 has been executed, in the management server 30 the user information receiving unit 36, as shown in FIG. 10, receives the user group information (step S40). The user information receiving unit 36 then passes the user group information returned from the user management server 70 to the access control information acquisition unit 37.

The access control information acquisition unit 37 compares the user group information received from the user information receiving unit 36 with the rights policy received from the rights policy acquisition unit 34, and specifies the access control information assigned to the corresponding user (step S38). Also, the access control information acquisition unit 37 passes the specified access control information to the path information generation unit 39.

In step S38, a plurality of pieces of access control information may be assigned to the user. In this case, in the present embodiment, a logical sum or a logical product is applied to the access control information.

Taking FIGS. 3 and 5 as an example, assume that the rights policy is rights policy A and the user is user A. In this case, since user A also belongs to group A, the access control information will be “view, edit, save, copy” of user A, and “view, edit, save, print” of group A. Here in the case where a logical sum is applied, user A will ultimately have the authority to “view, edit, save, print, copy”. On the other hand, in the case where a logical product is applied, user A will ultimately have the authority to “view, edit, save.”

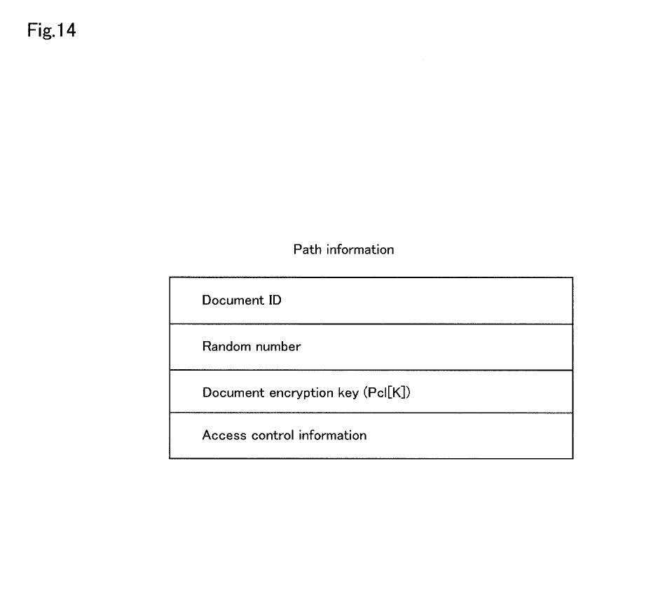

After execution of step S36 and step S38, the path information generation unit 39 combines the document ID and the random number acquired from the authentication-use information analysis unit 33, the document encryption key (Pcl[K]) acquired from the common key extraction unit 38, and the access control information acquired from the access control information acquisition unit 37 (step S41). The path information shown in FIG. 14 is thereby generated. The generated path information and the public key (Pcl) of the protected document control unit 11 acquired from the common key extraction unit 38 are then passed to the path information encryption unit 40. FIG. 14 shows an example of path information that is generated in the present embodiment.

Next, the path information encryption unit 40 encrypts the path information using the public key (Pcl) of the protected document control unit 11, and passes the encrypted path information to the path information transmission unit 41 (step S42).

Thereafter, the path information transmission unit 41 transmits the path information to the communication terminal 50 (step S43). At this time, the path information transmission unit 41 is able to use existing technology such as SSL to encrypt the path information to be transmitted, thereby further ensuring the security of the path information to be transmitted.

### Operations by Communication Terminal

When step S43 has been executed, in the communication terminal 50, the path information receiving unit 55, as shown in FIG. 9, receives the path information returned from the management server 30, and passes the returned path information to the path information encoding unit 56 (step S25).

Next, the path information encoding unit 56 encodes all of the received path information with a method capable of displaying the encrypted path information on a screen, such as QR Code (registered trademark) or BASE64, similarly to the authentication-use information encoding unit 16 of the terminal device 10 (step S26). Thereafter, the path information encoding unit 56 passes the encoded path information to the path information display unit 57.

Next, the path information display unit 57 displays the path information encoded by the path information encoding unit 56 on the display screen of the communication terminal 50 (step S27). The encoded path information is thereby conveyed to the user.

### Operations by Terminal Device

When step S27 has been executed, the path information acquisition unit 18 of the terminal device 10, as shown in FIG. 8, acquires the path information currently displayed on the screen of the communication terminal 50, in accordance with operation of the terminal device 10 by the user (step S9).

Specifically, for example, the terminal device 10 may be provided with a digital camera, and the path information may be converted to a two-dimensional code, such as QR Code (registered trademark), in step S26, and the two-dimensional code may be displayed on the screen of the communication terminal 50 in step S27. In this case, the path information acquisition unit 18 is able to acquire the code of the path information, by analyzing an image of the code captured by the user with the digital camera of the terminal device 10.

As another example, the authentication-use information may be encoded by BASE64 in step S26 and a character string or the like may be displayed in step S27. In this case, the path information acquisition unit 18 is able to acquire the code of the path information after an input operation by the user.

Next, the path information decoding unit 19 decodes the code of the path information acquired by the path information acquisition unit 18, and, furthermore, decrypts the encrypted path information using the private key (Scl) of the protected document control unit 11 (step S10). The path information decoding unit 19 then passes the document ID and the random number acquired from the path information to the path information collation unit 20 (step S11).

Next, the path information collation unit 20 collates the document ID received from the document information extraction unit 12 at step S2 and the random number received from the random number generation unit 13 by the authentication-use information generation unit 14 with the document ID and the random number received from the path information decoding unit 19 (step S12).

The path information collation unit 20 then determines from the collation result whether both the document IDs and the random numbers match (step S13). In the case where the determination result of step S13 indicates that the document IDs and the random numbers do not match, the protected document control unit 11 ends the processing. On the other hand, in the case where the determination result of step S13 indicates that the document IDs and the random numbers do match, the path information collation unit 20 notifies the path information decoding unit 19 that the collation result indicated that the document IDs and the random numbers match.

Next, when notified by the path information collation unit 20 that the collation result indicates that the document IDs and the random numbers match, the path information decoding unit 19 passes the document encryption key (Pcl[K]) to the common key acquisition unit 21 (step S14). Also, the path information decoding unit 19 passes the access control information to the access control unit 22 (step S18).

Next, the common key acquisition unit 21 decrypts the document encryption key (Pcl[K]) received from the path information decoding unit 19, using the private key (Scl) of the protected document control unit 11, and acquires a common key (K) (step S15).

Next, the common key acquisition unit 21 decrypts the protected document using the common key (K), and passes the protected document to the application program that is going to use the protected document (step S17). Also, the access control unit 22 controls the application that is using the protected document, in accordance with the access control information received from the path information decoding unit 19 (step S19). After execution of steps S17 and S19, the processing in the protected document control unit 11 ends.

### Effects of Embodiment

As described above, the present embodiment enables the following effects to be obtained.

In the embodiment, authentication by the management server 30 and acquisition of path information from the management server 30 are performed using a communication terminal 50 such as a mobile phone, a smart phone, or a tablet terminal. Thus, even when the terminal device 10 is in offline environment, the user is able to use protected documents on the terminal device 10 without connecting online. Also, because path information is transmitted from the management server 30, protected documents can be used based on the latest rights policy information. Furthermore, even in the case where the rights policy is changed after creation of a protected document, the change can be reflected.

In the present embodiment, at the time of using a protected document, a random number can be included in authentication-use information that is transmitted to the management server 30, and this random number can be collated with the random number of the path information returned from the management server 30. In this case, reuse of passwords can be prevented, allowing prevention of the leakage of information to be further assured.

### Program

A program according to the present embodiment can be a program that causes a computer to execute steps S1 to S19 shown in FIG. 8. The terminal device 10 according to the present embodiment can be realized by this program being installed on a computer and executed. In this case, a central processing unit (CPU) of the computer performs processing while functioning as the protected document control unit 11.

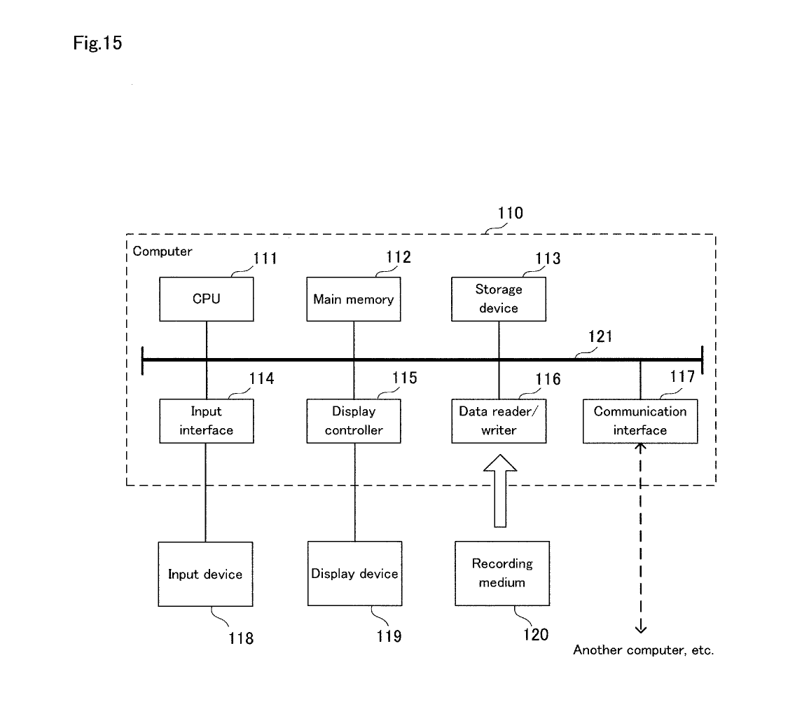

Here, the computer that realizes the terminal device 10 by executing the program according to the present embodiment will be described using FIG. 15. FIG. 15 is a block diagram showing an example of a computer that realizes the terminal device according to the present embodiment.

As shown in FIG. 15, the computer 110 is provided with a CPU 111, a main memory 112, a storage device 113, an input interface 114, a display controller 115, a data reader/writer 116, and a communication interface 117. These units are connected to each other so as to enable data communication, via a bus 121.

The CPU 111 implements various types of operations by expanding the program (codes) according to the present embodiment stored in the storage device 113 in the main memory 112, and executing these codes in a predetermined order. The main memory 112 typically is a volatile storage device such as DRAM (Dynamic Random Access Memory). Also, the program according to the present embodiment is provided in a state of being stored on a computer-readable recording medium 120. Note that the program according to the present embodiment may be distributed on the Internet connected via the communication interface 117.

Apart from a hard disk drive, specific examples of the storage device 113 include a semiconductor memory device such as flash memory. The input interface 114 mediates data transmission between the CPU 111 and input devices 118 such as a keyboard and a mouse. The display controller 115 is connected to a display device 119 and controls display on the display device 119.

The data reader/writer 116 mediates data transmission between the CPU 111 and the recording medium 120, and performs reading out of programs from the recording medium 120 and writing of the processing results of processing by the computer 110 to the recording medium 120. The communication interface 117 mediates data transmission between the CPU 111 and other computers.

Specific examples of the recording medium 120 include a general-purpose semiconductor memory device such as a CF (Compact Flash (registered trademark)) card or an SD (Secure Digital) card, a magnetic storage medium such as a flexible disk, and an optical storage medium such as a CD-ROM (Compact Disk Read Only Memory).

The abovementioned embodiments can be realized in part or in full by the following supplementary notes 1 to 12, but are not limited to the following disclosure.

### Supplementary Note 1

A document authority management system includes:

a management server that manages a rights policy defining a user authority of a document to be protected, and issues path information for using the document based on the rights policy;

a terminal device that protects the document based on the rights policy received from the management server, and, when use of the document is sought, requests the management server to issue the path information for using the document; and

a communication terminal configured to communicate wirelessly with the management server,

the terminal device, upon use of the document being sought when the terminal device is in an offline state with the management server, creating authentication-use information for requesting issuance of the path information, in a form supported by the communication terminal, and

the communication terminal, in a case where the authentication-use information is received, transmitting the received authentication-use information to the management server, and, upon the management server confirming that the authentication-use information is valid and transmitting the path information, changing the path information transmitted thereto into a form supported by the terminal device.

### Supplementary Note 2

In the document authority management system according to supplementary note 1, the terminal device, in order to change the authentication-use information into a form supported by the communication terminal, converts the authentication-use information into a code, and displays the resultant code on a screen of the terminal device, and

the communication terminal, in order to change the path information into a form supported by the terminal device, converts the path information into a code, and displays the converted path information on a screen of the communication terminal.

### Supplementary Note 3

In the document authority management system according to supplementary note 1 or 2, the terminal device, when in the offline state, adds a random number to the authentication-use information, and validates the path information transmitted from the management server to the communication terminal, on condition that the added random number matches a random number added to the path information.

### Supplementary Note 4

A terminal device for receiving, from a management server managing a rights policy that sets a user authority of a document to be protected, the rights policy, and protecting the document based on the received rights policy, includes:

a protected document control unit that, upon use of the document being sought when the terminal device is in an offline state with the management server, creates authentication-use information for requesting the management server to issue path information that is required in order to use the document, in a form supported by a communication terminal configured to communicate wirelessly with the management server,

the protected document control unit, in a case where the communication terminal receives the authentication-use information and transmits the received authentication-use information to the management server, and the management server confirms that the authentication-use information is valid and transmits the path information to the communication terminal, acquiring the path information from the communication terminal in a form supported by the terminal device.

### Supplementary Note 5

In the terminal device according to supplementary note 4, the protected document control unit, in order to change the authentication-use information into a form supported by the communication terminal, converts the authentication-use information into a code, and displays the resultant code on a screen of the terminal device.

### Supplementary Note 6

In the terminal device according to supplementary note 4 or 5, the protected document control unit, when the terminal device is in the offline state, adds a random number to the authentication-use information, and validates the path information transmitted from the management server to the communication terminal, on condition that the added random number matches a random number added to the path information.

### Supplementary Note 7

A document authority management method in which are used a management server that manages a rights policy defining a user authority of a document to be protected and issues path information for using the document based on the rights policy, a terminal device that protects the document based on the rights policy received from the management server and requests the management server to issue the path information for using the document when use of the document is sought, and a communication terminal configured to communicate wirelessly with the management server, includes the steps of:

(a) the terminal device, upon use of the document being sought when the terminal device is in an offline state with the management server, creating authentication-use information for requesting issuance of the path information in a form supported by the communication terminal;

(b) the communication terminal, in a case where the authentication-use information is received, transmitting the received authentication-use information to the management server; and

(c) the communication terminal, upon the management server confirming that the authentication-use information is valid and transmitting the path information to the communication terminal, changing the path information transmitted thereto into a form supported by the terminal device.

### Supplementary Note 8

In the document authority management method according to supplementary note 7, in the step of (a), the terminal device, in order to change the authentication-use information into a form supported by the communication terminal, converts the authentication-use information into a code, and displays the resultant code on a screen of the terminal device, and

in the step of (c), the communication terminal, in order to change the path information into a form supported by the terminal device, converts the path information into a code, and displays the converted path information on a screen of the communication terminal.

### Supplementary Note 9

The document authority management method according to supplementary note 7 or 8 further includes the step of (d) in a case where the terminal device adds a random number to the authentication-use information in the step of (a), validating the path information transmitted from the management server to the communication terminal, on condition that the added random number matches a random number added to the path information.

### Supplementary Note 10

A computer-readable recording medium stores a program for a computer to receive, from a management server managing a rights policy that sets a user authority of a document to be protected, the rights policy, and to protect the document based on the received rights policy, the program including instructions for causing the computer to execute the steps of:

(a) upon use of the document being sought when the computer is in an offline state with the management server, creating authentication-use information for requesting issuance of the path information, in a form supported by a communication terminal configured to communicate wirelessly with the management server; and

(b) in a case where the communication terminal receives the authentication-use information and transmits the received authentication-use information to the management server, and the management server confirms that the authentication-use information is valid and transmits the path information to the communication terminal, acquiring the path information from the communication terminal in a form supported by the computer.

### Supplementary Note 11

The computer-readable recording medium according to supplementary note 10, in the step of (a) in order to change the authentication-use information into a form supported by the communication terminal, the authentication-use information is converted into a code, and the resultant code is displayed on a screen of the terminal device.

### Supplementary Note 12

In the computer-readable recording medium according to supplementary note 10 or 11, the program includes an instruction for causing the computer to execute the step of (c) in a case where a random number is added to the authentication-use information in the step of (a), validating the path information transmitted from the management server to the communication terminal, on condition that the added random number matches a random number added to the path information.

As described above, the present invention enables application of the latest rights policy information and prevention of the leakage of confidential information to be achieved in the use of protected documents in an offline environment. The present invention is useful in systems that have confidential information such as design plans and customer information, and need to avoid the damage caused by leakage of information.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A document authority management system comprising:
a management server that manages a rights policy defining a user authority of a document to be protected, and issues path information for using the document based on the rights policy;
a terminal device that protects the document based on the rights policy received from the management server, and, when use of the document is sought, requests the management server to issue the path information for using the document; and
a communication terminal configured to communicate wirelessly with the management server,
wherein the terminal device, upon use of the document being sought when the terminal device is in an offline state with the management server, creates authentication-use information for requesting issuance of the path information, in a form supported by the communication terminal, and
the communication terminal, in a case where the authentication-use information is received, transmits the received authentication-use information to the management server, and, upon the management server confirming that the authentication-use information is valid and transmitting the path information, changes the path information transmitted thereto into a form supported by the terminal device.

2. The document authority management system according to claim 1,
wherein the terminal device, in order to change the authentication-use information into a form supported by the communication terminal, converts the authentication-use information into a code, and displays the resultant code on a screen of the terminal device, and
the communication terminal, in order to change the path information into a form supported by the terminal device, converts the path information into a code, and displays the converted path information on a screen of the communication terminal.

3. The document authority management system according to claim 1,
wherein the terminal device, when in the offline state, adds a random number to the authentication-use information, and validates the path information transmitted from the management server to the communication terminal, on condition that the added random number matches a random number added to the path information.

4. A terminal device that receives, from a management server managing a rights policy that sets a user authority of a document to be protected, the rights policy, and protects the document based on the received rights policy, comprising:
a protected document control unit that, upon use of the document being sought when the terminal device is in an offline state with the management server, creates authentication-use information for requesting the management server to issue path information that is required in order to use the document, in a form supported by a communication terminal configured to communicate wirelessly with the management server,
wherein the protected document control unit, in a case where the communication terminal receives the authentication-use information and transmits the received authentication-use information to the management server, and the management server confirms that the authentication-use information is valid and transmits the path information to the communication terminal, acquires the path information from the communication terminal in a form supported by the terminal device.

5. The terminal device according to claim 4,
wherein the protected document control unit, in order to change the authentication-use information into a form supported by the communication terminal, converts the authentication-use information into a code, and displays the resultant code on a screen of the terminal device.

6. The terminal device according to claim 4 or 5,
wherein the protected document control unit, when the terminal device is in the offline state, adds a random number to the authentication-use information, and validates the path information transmitted from the management server to the communication terminal, on condition that the added random number matches a random number added to the path information.

7. A document authority management method in which are used a management server that manages a rights policy defining a user authority of a document to be protected and issues path information for using the document based on the rights policy, a terminal device that protects the document based on the rights policy received from the management server and requests the management server to issue the path information for using the document when use of the document is sought, and a communication terminal configured to communicate wirelessly with the management server, the method comprising the steps of:
(a) the terminal device, upon use of the document being sought when the terminal device is in an offline state with the management server, creating authentication-use information for requesting issuance of the path information in a form supported by the communication terminal;
(b) the communication terminal, in a case where the authentication-use information is received, transmitting the received authentication-use information to the management server; and
(c) the communication terminal, upon the management server confirming that the authentication-use information is valid and transmitting the path information to the communication terminal, changing the path information transmitted thereto into a form supported by the terminal device.

8. In the document authority management method according to claim 7,
in the step of (a), the terminal device, in order to change the authentication-use information into a form supported by the communication terminal, converts the authentication-use information into a code, and displays the resultant code on a screen of the terminal device, and
in the step of (c), the communication terminal, in order to change the path information into a form supported by the terminal device, converts the path information into a code, and displays the converted path information on a screen of the communication terminal.

9. The document authority management method according to claim 7,
further comprising the step of (d) in a case where the terminal device adds a random number to the authentication-use information in the step of (a), validating the path information transmitted from the management server to the communication terminal, on condition that the added random number matches a random number added to the path information.

10. A computer-readable recording medium storing a program for a computer to receive, from a management server managing a rights policy that sets a user authority of a document to be protected, the rights policy, and to protect the document based on the received rights policy, the program including instructions for causing the computer to execute the steps of:
(a) upon use of the document being sought when the computer is in an offline state with the management server, creating authentication-use information for requesting issuance of the path information, in a form supported by a communication terminal configured to communicate wirelessly with the management server; and
(b) in a case where the communication terminal receives the authentication-use information and transmits the received authentication-use information to the management server, and the management server confirms that the authentication-use information is valid and transmits the path information to the communication terminal, acquiring the path information from the communication terminal in a form supported by the computer.

11. The computer-readable recording medium according to claim 10,
in the step of (a) in order to change the authentication-use information into a form supported by the communication terminal, the authentication-use information is converted into a code, and the resultant code is displayed on a screen of the terminal device.

12. In the computer-readable recording medium according to claim 10,
the program includes an instruction for causing the computer to execute the step of (c) in a case where a random number is added to the authentication-use information in the step of (a), validating the path information transmitted from the management server to the communication terminal, on condition that the added random number matches a random number added to the path information.
